(19) United States
(12) Patent Application Publication
(10) Pub. No.: US 2016/0283961 A1
(43) Pub. Date: Sep. 29, 2016

(54) SYSTEM AND METHOD FOR COGNITIVE COMPUTING INCENTIVE FRAMEWORK

(71) Applicant: International Business Machines Corporation, Armonk, NY (US)

(72) Inventors: Dario Gil, Katonah, NY (US); Joseph N. Kozhaya, Morrisville, NC (US); David O. S. Melville, New York, NY (US); Valentina Salapura, Chappaqua, NY (US)

(21) Appl. No.: 14/665,153

(22) Filed: Mar. 23, 2015

(51) Int. Cl. G06Q 30/02

(52) U.S. Cl. CPC G06Q 30/0218

(57) ABSTRACT

An approach for rewarding at least one user based on a response to a client. In the approach, a processor receives a request from a client, wherein the request comprises predetermined factors that are set by the client. A processor identifies a user from at teat one user with a response that comprises the set of predetermined factors. A processor sends the response from the at least one user to the client. A processors evaluates the response from the at least one user. A processor rewards the at least one user based on the evaluation of the response.

### TECHNICAL FIELD

The present invention relates generally to the field of cognitive computing to assist clients with requests, and more particularly to incentivizing users to assist the client when the cognitive computing system is unable to assist the client with their request.

### BACKGROUND

Cognitive computing systems redefine the nature of the relationship between people and their increasingly pervasive digital environment. They may play the role of assistant or coach for the user, and they may act virtually autonomously in many problem-solving situations. In order to achieve this new level of computing, cognitive systems must be adaptive, interactive, iterative, and contextual.

One area of cognitive computing is customer service for users. Customer service is a series of activities designed to enhance the level of customer satisfaction. The importance of customer service may vary by product or service, industry and customer. The perception of success of such interactions will be dependent on employees. From the point of view of an overall sales process engineering effort, customer service plays an important role in an organization's ability to generate income and revenue. From that perspective, customer service should be included as part of an overall approach to systematic improvement. A customer service experience can change the entire perception a customer has of the organization.

### SUMMARY OF THE INVENTION

In one aspect, the present invention provides a method for rewarding at least one user based on a response to a client. The method includes receives a request from a client, wherein the request comprises predetermined factors that are set by the client. The method further includes identifying a user from at teat one user with a response that comprises the set of predetermined factors. The method further includes sending the response from the at least one user to the client. The method further includes evaluating the response from the at least one user. The method further includes rewarding the at least one user based on the evaluation of the response.

In another aspect, the present invention provides a computer program product for rewarding at least one user based on a response to a client. The computer product includes one or more computer readable storage media and program instructions stored on the one or more computer readable storage media. The program instructions include program instructions to receive a request from a client, wherein the request comprises predetermined factors that are set by the client. The program instructions further include program instructions to identify a user from at teat one user with a response that comprises the set of predetermined factors. The program instructions further include program instructions to send the response from the at least one user to the client. The program instructions further include program instructions to evaluate the response from the at least one user. The program instructions further include program instructions to reward the at least one user based on the evaluation of the response.

In yet another aspect, the present invention provides a computer system for rewarding at least one user based on a response to a client. The computer system includes one or more computer processors, one or more computer readable storage media, and program instructions stored on the computer readable storage media for execution by at least one of the one or more processors. The program instructions include program instructions to receive a request from a client, wherein the request comprises predetermined factors that are set by the client. The program instructions further include program instructions to identify a user from at teat one user with a response that comprises the set of predetermined factors. The program instructions further include program instructions to send the response from the at least one user to the client. The program instructions further include program instructions to evaluate the response from the at least one user. The program instructions further include program instructions to reward the at least one user based on the evaluation of the response.

### BRIEF DESCRIPTION OF THE SEVERAL VIEWS OF THE DRAWINGS

FIG. 1 depicts a block diagram of a performance degradation detection and enhancement program, in accordance with one embodiment of the present invention.

FIG. 2 depicts a flowchart depicting operational steps for providing a client with relevant users to solve the client's request, within the computing environment of FIG. 1, in accordance with one embodiment of the present invention.

FIG. 3 depicts a block diagram of internal and external components of the computing device(s) and servers of FIG. 1, in accordance with one embodiment of the present invention.

FIG. 4 depicts a block diagram of a cloud computing node according to an embodiment of the present invention.

FIG. 5 depicts a block diagram of a cloud computing environment according to an embodiment of the present invention.

FIG. 6 depicts a depiction of an abstraction model layers according to an embodiment of the present invention.

### DETAILED DESCRIPTION TO THE PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware aspects that may generally be referred to herein as a “circuit,” “module”, or “system.” Furthermore, aspects of the present invention may take the form of a computer program product embodied in one or more computer-readable medium(s) having computer readable program code/instructions embodied thereon.

Embodiments of the present invention disclose a method, computer program product, and computer system, to connect a client with a relevant user and reward the user for successfully assisting the client with their request.

The present invention will now be described in detail with reference to the Figures.

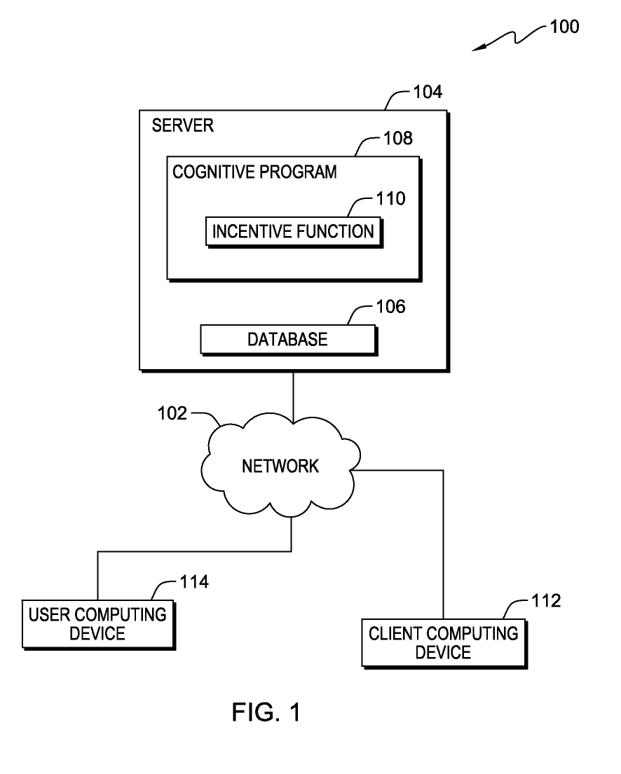

FIG. 1 depicts a block diagram of computing environment 100 in accordance with one embodiment of the present invention. FIG. 1 provides an illustration of one embodiment and does not imply any limitations regarding computing environment 100 in which different embodiments may be implemented. In the depicted embodiment, computing environment 100 includes, but is not limited to, network 102, server 104, client computing device 112, and/or user computing device 114. Computing environment 100 may include additional computing devices, servers, computers, components, or other devices not shown.

Network 102 may be a local area network (LAN), a wide area network (WAN) such as the Internet, any combination thereof, or any combination of connections and protocols that support communications between server 104 and other components connected to network 102, in accordance with embodiments of the invention. Network 102 may include wired, wireless, or fiber optic connections. In the depicted embodiment, network 102 connects server 104, client computing device 112, and/or user computing device 114. In other embodiments, network 102 connects server 104, client computing device 112, and/or user computing device 114 and additional computing devices, servers, computers, components, or other devices not shown.

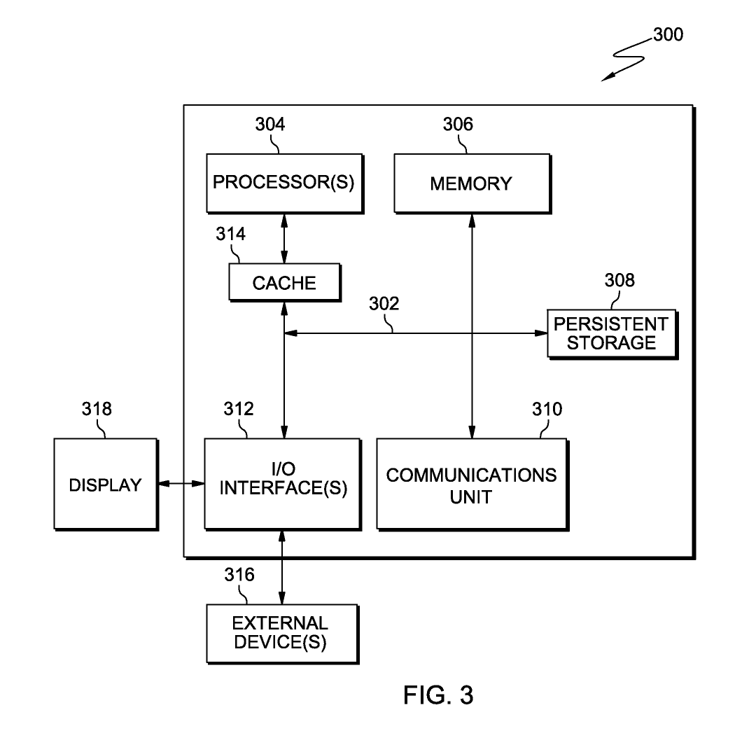

Server 104 may be a management server, a web server, or any other electronic device or computing system capable of processing program instructions and receiving and sending data. In some embodiments, server 104 may be a laptop computer, tablet computer, netbook computer, personal computer (PC), desktop computer, or any programmable electronic device capable of communicating with other components via network 102. In other embodiments, server 104 may represent a server computing system utilizing multiple computers as a server system, such as in a cloud computing environment. In another embodiment, server 104 represents a computing system utilizing clustered computers and components to act as a single pool of seamless resources. In the depicted embodiment, server 104 includes cognitive program 108 and database 106. In other embodiments, server 104 may include those and other components. Server 104 may include components, as depicted and described in further detail with respect to FIG. 3.

Database 106 may be a repository that may be written to and/or read by cognitive program 108 and incentive function 110. In one embodiment, information gathered by cognitive program 108 and incentive function 110 may be stored to database 106. In one embodiment, database 106 is a database management system (DBMS) used to allow the definition, creation, querying, update, and administration of a database(s). In the depicted embodiment, database 106 is stored on server 104 and connected to network 102. In other embodiments, database 106 may reside on a server, or another computing device, provided that database 106 is able to communicate with cognitive program 108 and incentive function 110.

Cognitive program 108 aides and assists the client with their request. In one embodiment, cognitive program 108 provides the client with a solution which cognitive program 108 stored in database 106. In another embodiment, cognitive program 108 stores information in database 106. In other embodiments, cognitive program 108 connects the client with a user based on temporal, social, financial, reputation, and other factors of the user and the user's relationship with the client. Those and other factors are used to determine the best match between the client's request and the user's relationship to the client and the client's request. The relationship can be created based on the knowledge and expertise of the user, the relationship to the client (family member, coworker, or friend), the user's reputation at solving requests, and the speed at which the user responds to the client's request. The factors in conjunction with other factors allow cognitive program 108 to connect the client with a user who is best suited to meet the client's demands. In other embodiments, cognitive program 108 connects the client with a quantity of users. In the depicted embodiment, cognitive program 108 is located on server 104. In other embodiments, cognitive program 108 can be located on other servers, computing devices, or computers provided cognitive program 108 can access client computing device 112, user computing device 114, and database 106 via network 102.

Incentive function 110 controls the flow of tokens between the user and the client. A token is a voucher which is used as currency by incentive function 110 to encourage users and clients to interact. Incentive function 110 controls how users and/or clients spend and receive tokens. For example, users and clients can spend their tokens on posting an inquiry with cognitive program 108, to advertise their services, for real money, and other actions which incentive function 110 determines what the client and/or user should spend tokens for. Examples of how users and/or clients can receive tokens include by answering an inquiry, by buying tokens, by listening/reading/viewing advertisements, and other actions which incentive function 110 determines that the user and/or the client should receive tokens for. The cost of those and other actions is determined by several factors including temporal, reputation, or social. For example, when a client receives a request, the cost of the request can be based on the difficulty of the request, the timeframe in which the client wants the response, and the reputation of the user the client would prefer to respond to the request. An example of how the relationship between the user and the client can affect the amount of tokens received can be affected by the relationship between the user and the client. A user who is a coworker, a family member, or social media friend would be more inclined to assist the client, and the relationship results in an alteration to the amount of tokens received for responding to the client's request. In one embodiment, incentive function 110 stores the information related to the tokens in database 106. In other embodiments, incentive function 110 stores the information related to the tokens in another database, server, computing device, or computer provided incentive function 110 accesses the information related to the tokens via network 102. In other embodiments, incentive function 110 may stand alone as a program located on server 104, client computing device 112, user computing device 114, or any other computing device, provided that incentive function 110 is accessible to cognitive program 108.

Client computing device 112 and user computing device 114 may be a desktop computer, laptop computer, tablet computer, netbook computer, personal computer (PC), desktop computer, mobile device, or any programmable electronic device capable of communicating via network 102. In other embodiments, client computing device 112 or user computing device 114 may be any electronic device or computing system capable of sending and receiving data, and communicating with server 104 via network 102. In the depicted embodiment, client computing device 112 and user computing device 114 are connected to server 104 via network 102.

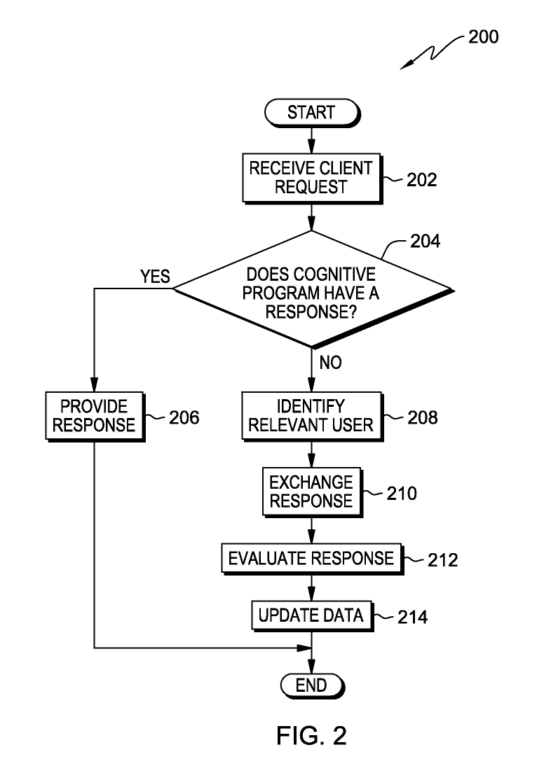

FIG. 2 depicts a flowchart 200 of the steps taken by cognitive program 108 for providing a client with relevant users to solve the client's request, within the computing environment of FIG. 1, in accordance with an embodiment of the present invention. Flowchart 200 depicts the analysis of the request and the method of supplying a client with a response to their request.

In step 202, cognitive program 108 receives the client's request from client computing device 112. The request can be for the translation of a document from the original language to a target language, or languages. In one embodiment, cognitive program 108 communicates with incentive function 110 to gather a quantity of tokens from the client for the request. Incentive function 110 determines the quantity of tokens based on a number of different criteria. The criteria for example, can be but are not limited to complexity of the request, preferred complexity of the response, preferred length of the response, or time frame the client wants the response to the request.

In decision 204, cognitive program 108 determines if cognitive program 108 has a response to the client's request that meets the client's criteria. In one embodiment, cognitive program 108 searches database 106 for a response to the client's request. In other embodiments, cognitive program 108 searches other databases, the Internet via cloud computing, or other sources to locate a response to the client's request. In one embodiment, if cognitive program 108 is able to locate a response to the client's request, cognitive program 108 communicates with incentive function 110 to adjust the amount of tokens which are received from the client. If a response to the client's request already exists, cognitive program 108 communicates the response to the client (Yes branch, proceed to step 206). If cognitive program 108 cannot locate a response which meets the client's criteria, cognitive program 108 identifies a user or users to assist the client (No branch, proceed to step 208).

In step 206, cognitive program 108 provides the response to the client which cognitive program 108 is able to locate in database 106. In other embodiments, cognitive program 108 provides the response to the client which cognitive program 108 is able to locate in other sources. Cognitive program 108 may store the response to the client's request in database 106 if cognitive program 108 located the response from a source other than database 106. In one embodiment, once the client receives the response, cognitive program 108 communicates with incentive function 110 which deducts the determined number of tokens from the clients account. In one embodiment, cognitive program 108 requires the client to rate the response to the request.

In step 208, cognitive program 108 identifies a relevant user who can assist the client with their request. Cognitive program 108 determines if a user is relevant by many factors including financial, temporal, reputation, or social. Cognitive program 108 determines a user which meets the client's criteria based off those and other factors. Client's criteria can be for example the time frame the client wants the response, the cost of the user, the complexity of the answer, or other factors related to the characteristics of the user or the characteristics of the response the user provides. Those and other criteria assist cognitive program 108 in gathering a quantity of users to potentially connect the client with. In other embodiments, cognitive program 108 selects a quantity of users to assist the client with their request. In other embodiments, cognitive program 108 selects a user or users which do not meet the client's criteria but are able to assist the client.

Some examples of a user's characteristics can be their knowledge in the technological area of the request, if the user is able to assist the client, or if the client can afford the user. Users who are knowledgeable in the technological area may for example have degrees in the field of study (e.g., a user with a PHD costs more tokens than a user with an MSE), may have answered similar requests in the past, or are related to the technology. Users who are willing to assist the client may be for example users who have been active, users who are willing to answer the request for given token reward, or users who are inclined to assist the client for other reasons not listed. Users who are related to the client can be for example family, friends, coworkers, or other forms of relation which would encourage the user to assist the client because of the relationship.

In step 210, cognitive program 108 exchanges the user's response from the user to the client. Cognitive program 108 receives the user response, and sends the response to the client. In one embodiment, cognitive program 108 stores the response in database 106 once cognitive program 108 receives the response. In other embodiments, cognitive program 108 exchanges a quantity of responses from one or more users. The responses can be stored in database 106 when cognitive program 108 receives the responses. In one embodiment, client and user exchange the response more than once allowing editing to be done to the response. The exchange of the response allows the user to expand upon areas of the response which the client needs more clarity on.

In step 212, cognitive program 108 evaluates the response from the user. The evaluation can be a rating given by the client. The rating can be based on if the response was helpful, punctual, clear, complete, and other factors related to the effectiveness of the response. The rating can adjust the tokens received by the user if cognitive program 108 communicates with incentive function 110. In one embodiment, cognitive program 108 exchanges a quantity of responses to the client. The client may select only one answer or rate each answer to determine a best answer. Each individual response receives a certain rating and cognitive program 108 communicates the ratings to incentive function 110. Incentive function 110 may allocate a portion of the tokens to each user. In other embodiments, only the highest rated response receives tokens from incentive function 110. In one embodiment, a response with a negative or low rating is charged tokens from incentive function 110.

In step 214, cognitive program 108 updates data related to the clients request. In one embodiment, cognitive program 108 updates database 106 with the response, or responses, which the client selected were the best response or responses to the client's request. In one embodiment, cognitive program 108 updates database 106 with the response or responses which cognitive program 108 received from the user or users. In one embodiment, incentive function 110 updates the transfer of tokens which between the client and the user or users. The transfer of tokens, for example, can relate to the tokens spent by the client, tokens received by the user or users, or any other transaction where tokens were transferred between a client, a user, and/or another entity. In other embodiments, cognitive program 108 and incentive function 110 update the data regarding the request that is stored in another storage location other than database 106.

FIG. 3 depicts a block diagram 300 of components of Server 104, client computing device 112, and/or user computing device 114, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server 104, client computing device 112, and/or user computing device 114 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any additional hardware components within a system. For example, communications fabric 302 can be implemented with one or more buses.

Memory 306 and persistent storage 308 are computer-readable storage media. In one embodiment, memory 306 includes random access memory (RAM) and cache memory 314. In general, memory 306 can include any suitable volatile or non-volatile computer-readable storage media.

Memory 112 is stored for execution by one or more of the respective computer processors 304 of server 104, client computing device 112, and/or user computing device 114 via one or more memories of memory 306 of server 104, client computing device 112, and/or user computing device 114. In the depicted embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media which is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in the examples, provides for communications with other data processing systems or devices, including server 104, client computing device 112, and/or user computing device 114. In the examples, communications unit 310 includes one or more network interface cards. Communications unit 310 may provide communications through the use of either or both physical and wireless communications links.

I/O interface(s) 312 allows for input and output of data with other devices that may be connected to server 104, client computing device 112, and/or user computing device 114. For example, I/O interface 312 may provide a connection to external device(s) 316 such as a keyboard, keypad, camera, a touch screen, and/or some other suitable input device. External device(s) 316 can also include portable computer-readable storage media such as, for example, thumb drives, portable optical or magnetic disks, and memory cards. Software and data used to practice embodiments of the present invention, e.g., function of statistical machine translation program 108 can be stored on such portable computer-readable storage media and can be loaded onto persistent storage 308 of server 104, client computing device 112, and/or user computing device 114 via I/O interface(s) 312 of server 104, client computing device 112, and/or user computing device 114. Software and data used to practice embodiments of the present invention, e.g., statistical machine translation program 108 can be stored on such portable computer-readable storage media and can be loaded onto persistent storage 308 of server 104, client computing device 112, and/or user computing device 114 via I/O interface(s) 312 of server 104, client computing device 112, and/or user computing device 114. I/O interface(s) 312 also connect to a display 318.

Display 318 provides a mechanism to display data to a user and may be, for example, a computer monitor.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and execute arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

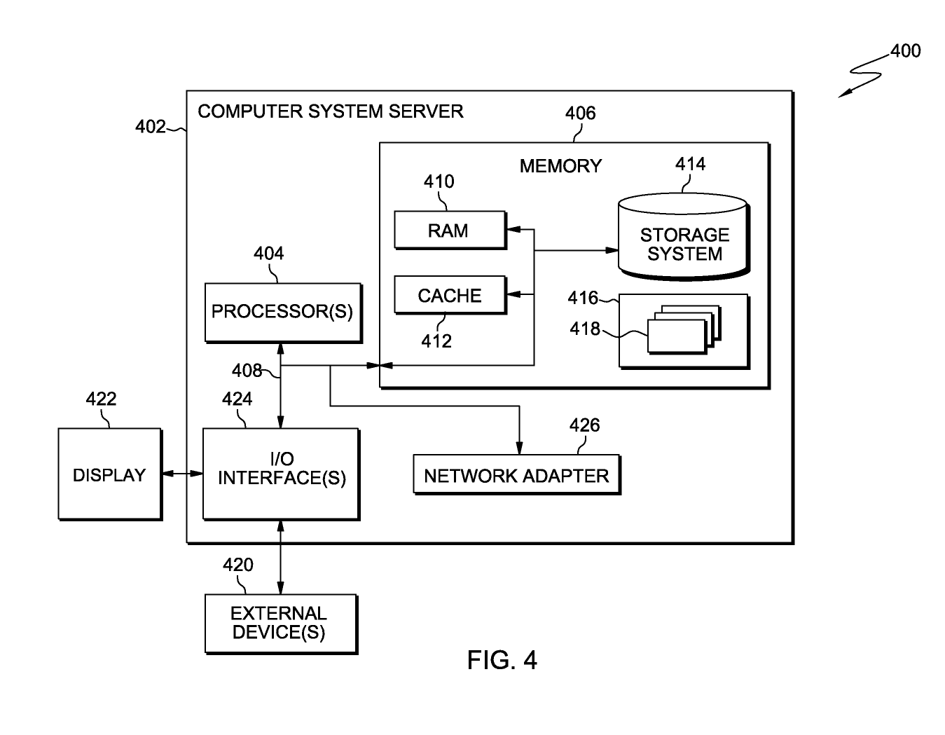

FIG. 4, a schematic of an example of a cloud computing node is shown. Cloud computing node 400 is only one example of a suitable cloud computing node and is not intended to suggest any limitation as to the scope of use or functionality of embodiments of the invention described herein. Regardless, cloud computing node 400 is capable of being implemented and/or performing any of the functionality set forth hereinabove.

In cloud computing node 400 there is a computer system/server 402, which is operational with numerous other general purpose or special purpose computing system environments or configurations. Examples of well-known computing systems, environments, and/or configurations that may be suitable for use with computer system/server 402 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 402 may be described in the general context of computer system executable instructions, such as program modules, being executed by a computer system. Generally, program modules may include routines, programs, objects, components, logic, data structures, and so on that perform particular tasks or implement particular abstract data types. Computer system/server 402 may be practiced in distributed cloud computing environments where tasks are performed by remote processing devices that are linked through a communications network. In a distributed cloud computing environment, program modules may be located in both local and remote computer system storage media including memory storage devices.

FIG. 4, computer system/server 402 in cloud computing node 400 is shown in the form of a general-purpose computing device. The components of computer system/server 402 may include, but are not limited to, one or more processors or processing units 402, a system memory 406, and a bus 408 that couples various system components including system memory 406 to processor(s) 404.

Bus 408 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 402 typically includes a variety of computer system readable media. Such media may be any available media that is accessible by computer system/server 402, and it includes both volatile and non-volatile media, removable and non-removable media.

System memory 406 can include computer system readable media in the form of volatile memory, such as random access memory (RAM) 410 and/or cache memory 412. Computer system/server 402 may further include other removable/non-removable, volatile/non-volatile computer system storage media. By way of example only, storage system 414 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 408 by one or more data media interfaces. As will be further depicted and described below, memory 406 may include at least one program product having a set (e.g., at least one) of program modules that are configured to carry out the functions of embodiments of the invention.

Program/utility 416, having a set (at least one) of program modules 418, may be stored in memory 406 by way of example, and not limitation, as well as an operating system, one or more application programs, other program modules, and program data. Each of the operating system, one or more application programs, other program modules, and program data or some combination thereof, may include an implementation of a networking environment. Program modules 418 generally carry out the functions and/or methodologies of embodiments of the invention as described herein.

Computer system/server 402 may also communicate with one or more external devices 420 such as a keyboard, a pointing device, a display 422, etc.; one or more devices that enable a user to interact with computer system/server 402; and/or any devices (e.g., network card, modem, etc.) that enable computer system/server 402 to communicate with one or more other computing devices. Such communication can occur via Input/output (I/O) interfaces 424. Still yet, computer system/server 402 can communicate with one or more networks such as a local area network (LAN), a general wide area network (WAN), and/or a public network (e.g., the Internet) via network adapter 426. As depicted, network adapter 426 communicates with the other components of computer system/server 402 via bus 408. It should be understood that although not shown, other hardware and/or software components could be used in conjunction with computer system/server 402. Examples, include, but are not limited to: microcode, device drivers, redundant processing units, and external disk drive arrays, RAID systems, tape drives, and data archival storage systems, etc.

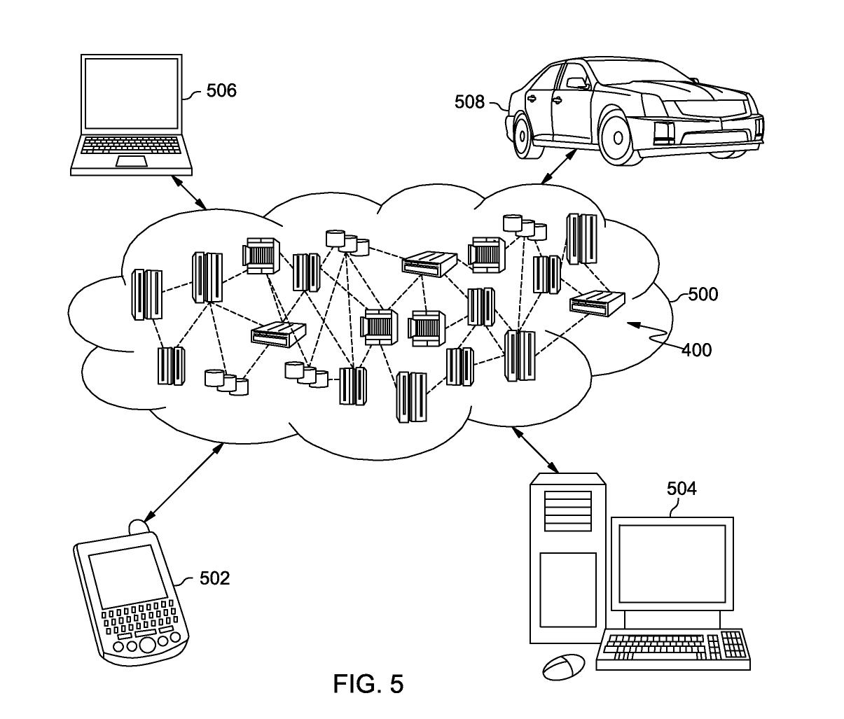

FIG. 5, illustrative cloud computing environment 500 is depicted. As shown, cloud computing environment 500 comprises one or more cloud computing nodes 400 with which local computing devices used by cloud consumers, such as, for example, personal digital assistant (PDA) or cellular telephone 502, desktop computer 504, laptop computer 506, and/or automobile computer system 508 may communicate. Nodes 400 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 502, 504, 506, 508 shown in FIG. 5 are intended to be illustrative only and that computing nodes 400 and cloud computing environment 500 can communicate with any type of computerized device over any type of network and/or network addressable connection (e.g., using a web browser).

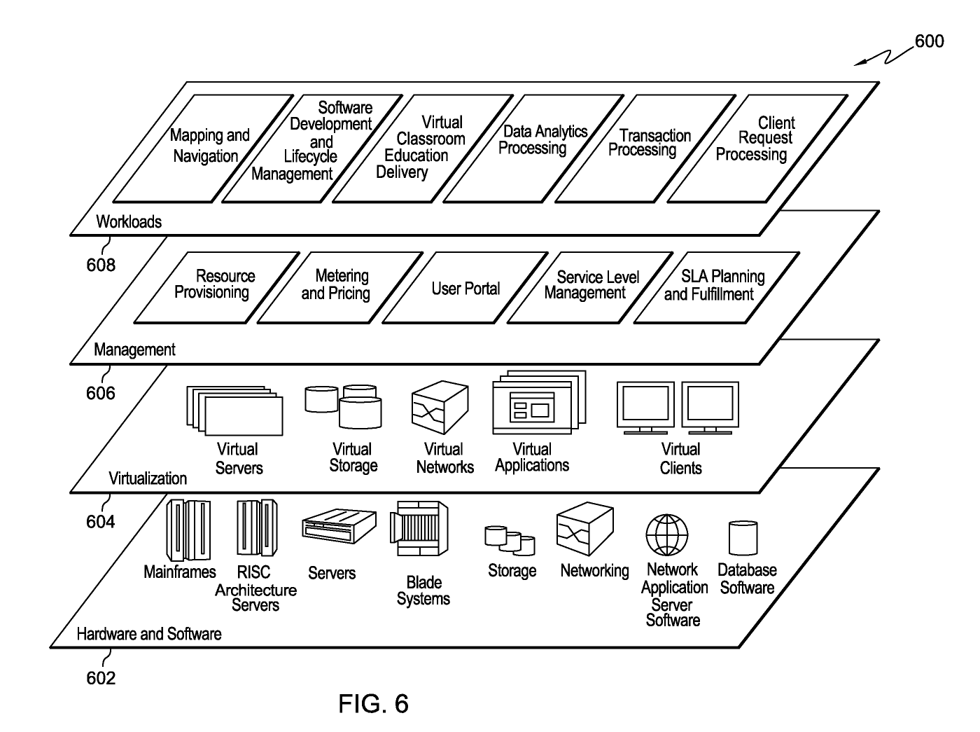

FIG. 6, a set of functional abstraction layers provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 602 includes hardware and software components. Examples of hardware components include: mainframes; RISC (Reduced Instruction Set Computer) architecture based servers; storage devices; networks and networking components. In some embodiments, software components include network application server software.

Virtualization layer 604 provides an abstraction layer from which the following examples of virtual entities may be provided: virtual servers; virtual storage; virtual networks, including virtual private networks; virtual applications and operating systems; and virtual clients.

In one example, management layer 606 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, procurement of, cloud computing resources for which a future requirement is anticipated in accordance with an SLA, and service orchestration and management provisions through management in a cloud marketplace.

Workloads layer 608 provides examples of functionality for which the cloud computing environment may be utilized. Examples of workloads and functions which may be provided from this layer include: mapping and navigation; software development and lifecycle management; virtual classroom education delivery; data analytics processing; transaction processing; mobile desktop; and client request processing.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for rewarding at least one user based on a response to a client, the method comprising:
receiving, by one or more processors, a request from a client, wherein the request comprises predetermined factors that are set by the client;
identifying, by one or more processors, at least one user with a response that comprises the set of predetermined factors;
sending, by one or more processors, the response from the at least one user to the client;
evaluating, by one or more processors, the response from the at least one user; and
rewarding, by one or more processors, the identified user based on the evaluation of the response.

2. The method of claim 1, further comprising:
searching, by one or more processors, a quantity of information for a known response to the request; and
communicating, by one or more processors, the known response to the client.

3. The method of claim 1, wherein the set of predetermined factors is based, at least in part, on temporal factors, financial factors, reputation factors, and social factors.

4. The method of claim 1, wherein evaluating the response from the at least one user comprises:
scoring, by one or more processors, the response from the at least one user; and
determining, by one or more processors, a quantity of tokens based on the score and the set of predetermined factors.

5. The method of claim 1, further comprising:
determining a first quantity of users from the at least one user, that meet the set of predetermined factors.

6. The method of claim 5, further comprising:
exchanging, by one or more processors, a quantity of responses between the first quantity of users and the client;
scoring, by one or more processors, the quantity of responses from the first quantity of users; and
determining, by one or more processors, a quantity of tokens based on the score and the set of predetermined factors for the quantity of responses from the first quantity of users.

7. The method of claim 6, wherein the first quantity of users are prioritized, based, at least in part, on the set of predetermined factors.

8. A computer program product for rewarding at least one user based on a response to a client, the method comprising:
one or more computer readable storage media and program instructions stored on the one or more computer readable storage media, the program instructions comprising:
program instructions to receive a request from a client, wherein the request comprises predetermined factors that are set by the client;
program instructions to identify at least one user with a response that comprises the set of predetermined factors;
program instructions to send the response from the at least one user to the client;
program instructions to evaluate the response from the at least one user; and
program instructions to reward the at least one user based on the evaluation of the response.

9. The computer program product of claim 8, further comprising:
program instructions to search a quantity of information for a known response to the request; and
program instructions to communicate the known response to the client.

10. The computer program product of claim 8, wherein the set of predetermined factors is based, at least in part, on temporal factors, financial factors, reputation factors, and social factors.

11. The computer program product of claim 8, wherein evaluating the response from the at least one user comprises:
program instructions to score the response from the user; and
program instructions to determine a quantity of tokens based on the score and the set of predetermined factors.

12. The computer program product of claim 8, further comprising:
program instructions to determine a first quantity of users from the at least one user, that meet the set of predetermined factors.

13. The computer program product of claim 12, further comprising:
program instructions to exchange a quantity of responses between the first quantity of users and the client;
program instructions to score the quantity of responses from the first quantity of users; and
program instructions to determine a quantity of tokens based on the score and the set of predetermined factors for the quantity of responses from the first quantity of users.

14. The computer program product of claim 13, wherein the first quantity of users are prioritized, based, at least in part, on the set of predetermined factors.

15. A computer system for rewarding at least one user based on a response to a client, the method comprising:
one or more computer processors, one or more computer readable storage media, and program instructions stored on the one or more computer readable storage media for execution by at least one of the one or more processors, the computer instructions comprising:
program instructions to receive a request from a client, wherein the request comprises predetermined factors that are set by the client;
program instructions to identify a at least one user with a response that comprises the set of predetermined factors;
program instructions to send a response from the at least one user to the client;
program instructions to evaluate the response from the at least one user; and
program instructions to reward the at least one user based on the evaluation of the response.

16. The computer system of claim 15, further comprising:
program instructions, stored on the one or more computer readable storage media for execution by at least one of the one or more processors, to search a quantity of information for a known response to the request; and
program instructions, stored on the one or more computer readable storage media for execution by at least one of the one or more processors, to communicate the known response to the client.

17. The computer system of claim 15, wherein the set of predetermined factors is based, at least in part, on temporal factors, financial factors, reputation factors, and social factors.

18. The computer system of claim 15, wherein evaluating the response from the at least one user comprises:
program instructions, stored on the one or more computer readable storage media for execution by at least one of the one or more processors, to score the response from the at least one user; and
program instructions, stored on the one or more computer readable storage media for execution by at least one of the one or more processors, to determine a quantity of tokens based on the score and the set of predetermined factors.

19. The computer system of claim 15, further comprising:
program instructions, stored on the one or more computer readable storage media for execution by at least one of the one or more processors, to determine a first quantity of users from the at least one users, that meet the set of predetermined factors.

20. The computer system of claim 19, further comprising:
program instructions, stored on the one or more computer readable storage media for execution by at least one of the one or more processors, to exchange a quantity of responses between the first quantity of users and the client;
program instructions, stored on the one or more computer readable storage media for execution by at least one of the one or more processors, to score the quantity of responses from the first quantity of users; and
program instructions, stored on the one or more computer readable storage media for execution by at least one of the one or more processors, to determine a quantity of tokens based on the score and the set of predetermined factors.
